(19) United States
(12) Patent Application Publication
(10) Pub. No.: US 2025/0079896 A1
(43) Pub. Date: Mar. 6, 2025

(54) METHOD FOR OPERATING AN INDUCTIVE COUPLER

(71) Applicant: Turck Holding GmbH, Halver (DE)

(72) Inventors: Lutz Göbel, Jahnsdorf (DE); Tobias Gerz, Schwarzenberg (DE)

(73) Assignee: Turck Holding GmbH, Halver (DE)

(21) Appl. No.: 18/815,899

(22) Filed: Aug. 27, 2024

(30) Foreign Application Priority Data
Sep. 1, 2023 (DE) 10 2023 123 588.5

(51) Int. Cl. H02J 50/12; H02J 50/80; H02J 50/90

(52) U.S. Cl. CPC H02J 50/12; H02J 50/80; H02J 50/90

(57) ABSTRACT

A method for operating a primary device for inductive power transmission, wherein the primary device includes a first operating mode and a second operating mode, wherein the primary device is designed such that the first and the second operating mode can be activated, the method comprising, when the first operating mode is activated, exciting a primary resonant circuit of the primary device for transmitting a secondary power to a secondary resonant circuit of a secondary device coupled to the primary device; and when the second operating mode is activated, exciting the primary resonant circuit with a standby power and measuring a standby operating parameter; wherein detecting a target object in a detection area based on the measured standby operating parameter; and generating an output signal.

### CROSS REFERENCE TO RELATED APPLICATIONS

This application claims priority to German patent application 10 2023 123 588.5 filed on Sep. 1, 2023, which is hereby incorporated by reference in its entirety.

### TECHNICAL FIELD

The present disclosure relates to a method for operating an inductive coupler and to a system.

### BACKGROUND

Systems in which an inductive power transmission between a primary device (transmitter) and a secondary device (receiver) takes place via an electromagnetic field in generally exist. The primary device here is, optionally, the active part that is coupled to an external power supply and can inductively transmit power to the secondary device as the passive part.

In order to ensure optimum power transmission, certain boundary conditions of the arrangement of the primary and secondary devices in relation to one another must be met. An apparatus for the contactless transmission of electrical power is known from EP 2 216 870 A2. In said document, it is determined whether the coils on the primary and secondary sides are located at a suitable distance from one another in order to allow efficient power transmission.

It is also the intention to ensure that no foreign objects are located within the range of the coupler arrangement to which energy is unintentionally released and which may potentially heat up dangerously. In order to avoid this problem, a number of different methods have been proposed, in which the foreign object is typically detected during a power transmission within the coupler arrangement.

One possible object of the present disclosure may be to improve the known methods and systems in such a way that foreign objects can be identified efficiently and the couplers can be used in many ways.

### SUMMARY

A method for operating a primary device for inductive power transmission, wherein the primary device includes a first operating mode and a second operating mode, wherein the primary device is designed such that the first and the second operating mode can be activated. The method comprises, when the first operating mode is activated, exciting a primary resonant circuit of the primary device for transmitting a secondary power to a secondary resonant circuit of a secondary device coupled to the primary device; when the second operating mode is activated, exciting the primary resonant circuit with a standby power and measuring a standby operating parameter; detecting a target object in a detection area based on the measured standby operating parameter; and generating an output signal.

A primary device for inductive power transmission, comprises a primary resonant circuit; and a control unit. The primary device is designed to transmit a secondary power via a primary resonant circuit to a secondary resonant circuit of a secondary device coupled to the primary device when a first operating mode is activated; and to excite the primary resonant circuit with a standby power when a second operating mode is activated; and wherein the control unit is designed to measure a standby operating parameter of the primary device in the activated second operating mode, to detect a target object in a detection area based on the measured standby operating parameter, and to generate an output signal.

### BRIEF DESCRIPTION OF THE DRAWINGS

Further optional details of the disclosure will now be explained in more detail below and based on exemplary embodiments shown in the drawings, in which:

FIG. 1 shows an exemplary embodiment of the primary device and a secondary device coupled thereto for inductive power transmission;

FIG. 2 shows the exemplary embodiment of the primary device and a detected target object;

FIG. 3 shows an exemplary embodiment of the method; and

FIGS. 4 and 5 show example measurement results during operation of the primary device.

### DESCRIPTION OF EXEMPLARY AND OPTIONAL EMBODIMENTS

According to one embodiment a method for operating a primary device for inductive power transmission may be provided, wherein at least one first operating mode and a second operating mode can be activated for the primary device. In this case, when the first operating mode is activated, a primary resonant circuit of the primary device is excited so that a secondary power can be transmitted to a secondary resonant circuit of a secondary device coupled to the primary device. Furthermore, when the second operating mode is activated, the primary resonant circuit is excited with a standby power and a standby operating parameter is measured. Here, a target object, optionally a metallic target object, is detected in a detection area based on the measured standby operating parameter and an output signal is generated.

Optionally, in the second operating mode, optionally in a standby mode, a metallic object can thus be identified in the electromagnetic field of the primary device. Optionally, in the second operating mode, the primary resonant circuit is excited at a low voltage and a fixed frequency. This generates an electromagnetic field and, if a secondary device is detected, the first operating mode can furthermore be activated and an inductive power transmission can be carried out.

The method extends the possibilities for using the inductive coupler by virtue of the primary side being able to be used as a sensor, for example as a limit switch, even while no energy is transmitted to a secondary device.

In the second operating mode, optionally in a standby state, the primary device can thus be used as a proximity switch, especially if it is not coupled to a secondary device; in a particular embodiment of the method, provision may be made for the primary device not to be able to be coupled to a secondary device in the second operating mode; typically, however, the primary device will couple to a secondary device as soon as a secondary device ready for coupling is identified in standby mode.

The term “standby” is understood here as a state in which the primary device is not coupled to a secondary device for inductive power transmission at one time.

The primary frequency at which the primary resonant circuit is excited in the second operating mode can be set so that a specific standby power of the primary resonant circuit is maintained. When a metallic object is within the range of the electromagnetic field of the primary resonant circuit, it takes up an electrical power of the electromagnetic field and thus changes the impedance of the entire system of the primary resonant circuit and target object. This change can be detected, for example, by the fact that a higher primary current for exciting the primary resonant circuit is established at a predetermined primary frequency.

The increased primary current therefore allows conclusions to be drawn qualitatively about the presence of the target within the range of the electromagnetic field of the primary resonant circuit. It also allows quantitative evaluation of the distance and/or position of the target object relative to the primary resonant circuit.

Provision may be made for the primary device to switch over between the first and second operating mode depending on whether a secondary device is identified and coupled in order to carry out an inductive power transmission in the first operating mode, or whether no secondary device is coupled and a target object, optionally a metallic foreign object, is detected in the standby mode of the primary device.

In one embodiment, the first operating mode is activated when the primary device is coupled to the secondary device, especially when a data connection to the secondary device is established in order to initiate an inductive power transmission.

The first operating mode can be activated, for example, by means of a user input or automatically when a secondary device is coupled to the primary device, optionally when the primary device is coupled to the secondary device for inductive power transmission and, optionally, for data transmission. If the second operating mode is activated at this time, provision is made, optionally, for it to be deactivated. Optionally, the first and second operating modes therefore cannot be activated simultaneously.

In one embodiment, a user input is detected and the first or second operating mode is activated depending on the user input. In this case, optionally when the second operating mode is activated, the standby power of the primary resonant circuit is determined depending on the user input.

The double use of the primary device can therefore be set, optionally, by the user by means of a user input. As an alternative or in addition, the primary device is able to automatically evaluate whether the inductive power transmission function should be activated in the first operating mode for an available and coupled secondary side, or whether the metal identification function should be activated in the second operating mode.

In the event that the user decides to use the primary side for metal identification, in the second operating mode, the standby power, that is to say optionally the voltage for generating the electromagnetic field, can be increased over a lower base value and/or the frequency of the primary resonant circuit can be varied. This enables a greater range and more accurate metal detection.

In the event that the primary side automatically switches over between the first and second operating modes, the range may initially be smaller, but it can be automatically extended by the same procedure as in the user setting explained above when metal is detected.

In a further embodiment, when the first operating mode is activated, a secondary power parameter of the secondary device is measured and a primary frequency at which the primary resonant circuit is excited is controlled in such a way that a predetermined value of the secondary power parameter is obtained.

Optionally, a standby operating parameter is measured, such as a primary current intensity (I_pri) that flows from the link capacitor into an amplifier and the primary resonant circuit, or an input current of the primary device (I_in).

In one development, when the second operating mode is activated, the primary resonant circuit is excited at a predetermined primary frequency. Optionally, the measured and evaluated standby operating parameter includes a primary current (I_pri) or an input current intensity of the primary device (I_in).

Optionally, a power parameter of the primary device can be used as standby operating parameter of the primary device, such as a primary current intensity (I_pri) that flows from a link capacitor into an amplifier and the primary resonant circuit, or an input current of the primary device (I_in); a primary frequency of the primary resonant circuit can also be used as standby operating parameter.

In one embodiment, the target object is detected in the detection area by comparing the power parameter with a predetermined threshold value. In this case, the power parameter is optionally determined using calibration data or a characteristic curve.

In a further embodiment, when detecting the target object in the detection area, a distance between the target object and the primary device or a distance between the target object and the primary resonant circuit and/or a position thereof relative thereto is determined.

For example, a distance can be determined based on a characteristic curve and/or based on a plurality of threshold values, each of which are assigned to specific distances, wherein the undershooting or overshooting of one of the specific distances is detected by a comparison with the respectively assigned threshold value.

In one development, the output signal includes a switching signal and/or a warning signal. For example, a signal for switching a device on or off can be generated and output if the distance of the target object falls below a certain value. It is also possible to generate a signal that prevents coupling and/or inductive power transmission when a foreign object is identified within range of the primary device. It is also possible to generate a signal that is used to attempt coupling with an identified secondary device in the vicinity if the secondary power parameters do not allow power transmission when data is transmitted.

When coupling the primary device and the secondary device, optionally a data connection is established, optionally simultaneously with and optionally in parallel with a connection for the inductive power transmission.

The primary device for inductive power transmission comprises a primary resonant circuit and a control unit. In this case, the primary device is set up to transmit a secondary power via the primary resonant circuit to a secondary resonant circuit of a secondary device coupled to the primary device when a first operating mode is activated and to excite the primary resonant circuit with a standby power when a second operating mode is activated. In this case, the control unit is set up in the activated second operating mode to measure a standby operating parameter of the primary device and to detect a target object in a detection area based on the measured standby operating parameter and to generate an output signal.

The control unit, which is used to switch over between the first and second operating mode and/or which is used to evaluate the output signal, may be included in the primary device or it may be provided as an external unit that is coupled, optionally through data technology, to the primary device.

The primary device is designed, optionally, to carry out the method described in the present case. It therefore has the same advantages as the method and it can be developed in a manner analogous to the presently described embodiments of the method.

In one embodiment of the primary device, the control unit is set up, when the second operating mode is activated, to control a primary frequency at which the primary resonant circuit is excited so that a predetermined primary frequency is obtained, and to measure a standby operating parameter, wherein the standby operating parameter includes, optionally, a primary current (I_pri) flowing from a link capacitor into an amplifier and the primary resonant circuit, or an input current (I_in) of the primary device.

When the primary device is operated as a proximity sensor in the second operating mode, for example, the input current into the resonant circuit of the primary side (I_pri) is measured and evaluated. If the current I_pri increases above an application-dependent threshold value, a metallic object is considered to be detected.

In one development, the primary device comprises an interface for data transmission to an external unit, optionally a network interface, and the control unit is set up to transmit the output signal via the interface to the external unit.

As a result, for example, a piece of information regarding whether a metallic object is located in the electromagnetic field of the primary device and/or at what distance and/or in what position relative to the primary device the object is arranged can be output to the external unit.

The interface may be set up, for example, to establish data communication for evaluation at a superordinate control level by means of IO-Link. Optionally, the primary device may be configured as an independent IO-Link device.

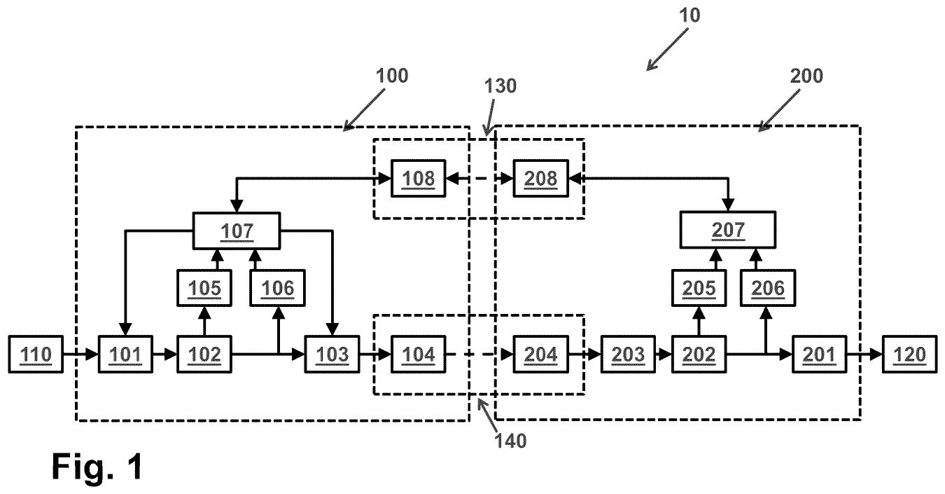

A system 10 for inductive power transmission is explained using an exemplary embodiment of the primary device with reference to FIG. 1.

The system 10 comprises a primary device 100, in this case a transmitter 100, and a secondary device 200, in this case a receiver 200.

The system 10 comprises the primary device 100 and the secondary device 200.

In the state shown in FIG. 1, the primary device 100 and the secondary device 200 are coupled and contactless power transmission is carried out.

In this case, a first operating mode of the primary device 100 is activated.

In this first operating mode, a primary resonant circuit of the primary device is excited so that a secondary power can be transmitted to a secondary resonant circuit of a secondary device 200 coupled to the primary device 100.

In the exemplary embodiment, the primary device 100 comprises a single coil 104 located in a (primary) resonant circuit for inductive energy transmission between the coupled primary device 100 and secondary device 200, wherein the primary device 100 takes on the role of the transmitter 100.

An input 110 on the primary side supplies electrical power to the primary device 100 and the secondary device 200 outputs electrical power on the secondary side via an output 120.

The primary device 100 further comprises a drive unit 107 for adjusting the load-dependent and distance-dependent resonant circuit frequency as well as a voltage converter 101 with a constant output voltage and a voltage link 102 for adjusting the input voltage to the resonant circuit voltage.

The primary device 100 further comprises an amplifier 103, optionally a current-mode amplifier, for adjusting the control signals of the drive unit 107 to the resonant circuit with the single coil 104, and a current measuring unit 106 between the voltage link 102 and an amplifier 103.

The primary device 100 further comprises a voltage measuring unit 105 on the voltage link 102 and an evaluation and drive unit 107 for driving the voltage converter 101 and the amplifier 103.

The primary device 100 further comprises an interface for data transmission 108 between a coupled primary device 100 and secondary device 200, wherein, optionally, an IO-Link method can be used to operate a data connection with the secondary device 200.

The secondary device 200 also comprises a single coil 204 located in a (secondary) resonant circuit for inductive energy transmission between the coupled primary device 100 and the secondary device 200, wherein the secondary device 200 takes on the role of the receiver 200.

The secondary device 200 further comprises a rectifier 203 with a voltage link 202 for storing the received energy.

The secondary device 200 additionally comprises a voltage converter 201 for adjusting the link voltage to the output voltage and a current measuring unit 206 between the voltage link 202 and the voltage converter 201.

The secondary device 200 further comprises a voltage measuring unit 205 on the voltage link 202 and an interface for data transmission 208 between the secondary device 200 and the primary device 100 coupled thereto using data technology.

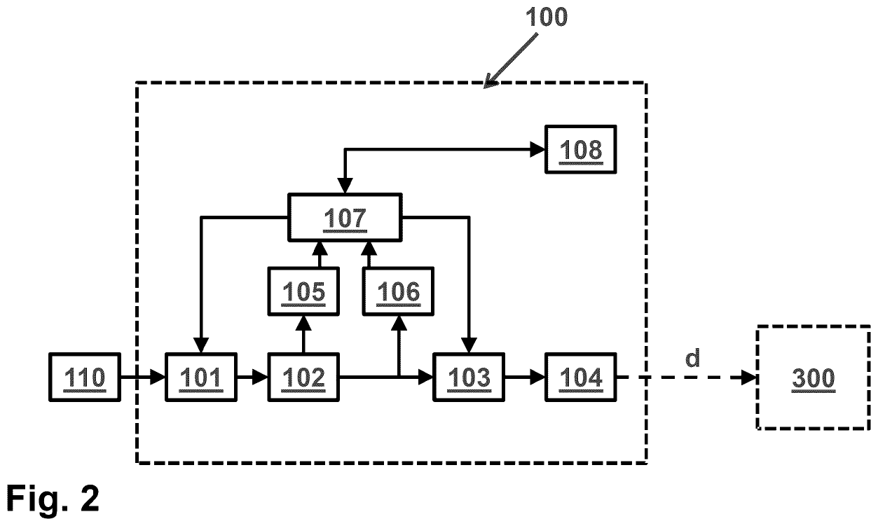

The exemplary embodiment of the primary device 100 with a detected target object is explained with reference to FIG. 2. The above explanations with reference to FIG. 1 are taken as a starting point and similar or identical elements are not described again in detail.

In the case shown here, the primary device 100 is constructed as explained with reference to FIG. 1, but it is not coupled to a secondary device 200 and there is no inductive power transmission taking place.

A second operating mode of the primary device 100 is activated, which in this case is a standby mode.

With the second operating mode activated, the primary resonant circuit with the single coil 104 is supplied with a standby power and a standby operating parameter is measured, based on which a target object 300 is detected in a detection area and an output signal is generated.

The target object 300, which in this case is a “foreign object” 300, is a metallic body arranged at a distance d from the single coil 104 of the primary resonant circuit.

Optionally, in the exemplary embodiment, a “detection area” is defined based on a maximum distance at which a target object 300 is detectable, optionally a range of an electromagnetic field generated by the primary device 100.

The standby power with which the primary resonant circuit is supplied is significantly lower in this exemplary embodiment than a typical power that is used in inductive power transmission. For example, the supply may be carried out with a standby power of up to 5 W, preferably up to 2 W.

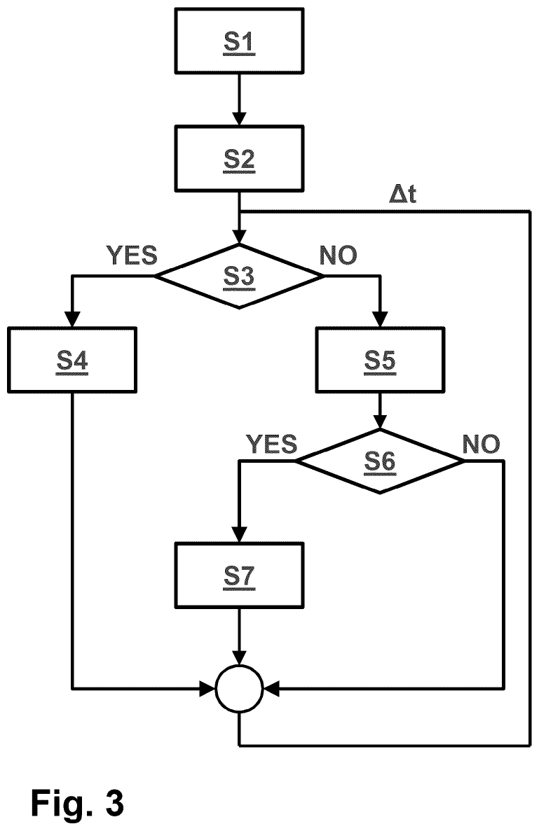

An exemplary embodiment of the method is described with reference to FIG. 3. Optionally, the above-described embodiment of a primary device 100 is taken as a starting point.

The method begins in a step S1, optionally with a start-up routine that includes, for example, initializing the primary device 100. For initialization, a data connection to a network can be used, via which the primary device 100 is connected to a controller, for instance.

In the example, the start-up routine of the first step S1 includes parameterization of the primary device. In this case, in order to activate the second operating mode, a function as a distance sensor or a proximity switch is activated and a link voltage U_{ZK} is set during standby mode.

For example, a value of 5 V or 18 V can be set as the link voltage U_{ZK}, wherein a smaller detection area is possible at 5 V, while the detection area is larger at 18 V.

In a step S2, the primary device 100 is operated in a standby mode, which corresponds to the second operating mode in the exemplary embodiment. The primary device is initialized in this state and ready to detect an existing secondary side or a metallic object or a target object 300.

In the case of a limited range, as is obtained, for example, with a link voltage U_{ZK} of 5 V, a maximum distance dₘₐₓ for detecting a secondary device or a metallic object may be approximately up to 7 mm. The standby power during operation in this case is approximately P≈1.0 W.

In the case of an extended range, as is obtained, for example, with a link voltage U_{ZK} of 18 V, a maximum distance dₘₐₓ for detecting a secondary device or a metallic object may be approximately up to 18 mm. The standby power during operation in this case is approximately P≈2.5 W.

In a further step S3, a check is carried out to determine whether a secondary device 200 is detected within the range of the electromagnetic field of the primary side 100.

As explained above, this detection may be performed, for example, at a link voltage U_{ZK} of 5 V up to a maximum distance dₘₐₓ of approximately up to 7 mm. In the case of an extended variant with, for example, a link voltage U_{ZK} of 18 V, the maximum distance dₘₐₓ for detecting a secondary device may be approximately up to 18 mm, for instance.

In a further step S4, when a secondary device 200 has been detected, the first operating mode for the primary device 100 is activated and said primary device is coupled to the secondary device 200 for inductive power transmission. A data connection is established for this purpose. Furthermore, contactless, inductive power transmission is carried out via an electromagnetic field that is generated by the primary device 100 and received by the secondary device 200.

For example, for the limited range described above, a maximum distance for the energy transmission at dₘₐₓ may be <=7 mm; for the extended range described above, a maximum distance for the detection of a metallic object at dₘₐₓ may be >7 mm.

In a further step S5, if no secondary device 200 is present and/or coupled to primary device 100, the second operating mode for the primary device 100 is activated. The primary device 100 is then used as a distance sensor or proximity switch that detects the presence of a target object 300 in the detection area, wherein the distance d is further determined.

In the exemplary embodiment, provision is made in the execution of step S5 for a check to first be carried out to determine whether the extended functionality of the primary device is set so that, in the absence of a secondary side, the primary device is to be operated as a distance sensor or proximity switch or as a detector for a target object 300. If the extended functionality is not set, optionally a third operating mode is activated in which no detection takes place in standby.

When the second operating mode is activated, within a loop with a fixed time interval, in the example every 10 ms, a check is regularly carried out to determine whether a secondary device is coupled and thus, if necessary, to switch over to the first operating mode for the inductive power transmission.

As long as no secondary side is detected, a metallic target object 300 is detected in a step S6 when the second operating mode is activated. For this, a check is carried out to determine whether a metallic object is located in the electromagnetic field of the primary device.

To detect a target object 300, the primary resonant circuit of the primary device 100 is operated with a fixed link voltage U_{ZK} in the second operating mode. At a given fixed primary frequency and link voltage, a primary current Iₚᵣᵢ and/or an input current Iᵢₙ of the primary device 100 is measured and evaluated. The primary current Iₚᵣᵢ or the input current Iᵢₙ changes due to a change in the impedance of the primary resonant circuit when there is a metallic object present. The measured primary current Iₚᵣᵢ or input current Iᵢₙ of primary device 100 is then evaluated.

If the primary current Iₚᵣᵢ or the input current Iᵢₙ exceeds a certain threshold value, it can be assumed that a metallic target object 300 is located in the detection area or within the range of the primary device 100. The size of the detection area or the range in this case depends, optionally, on the level of the link voltage U_{ZK}, since the primary resonant circuit is operated with a higher standby power at a higher link voltage U_{ZK}.

As an alternative or in addition to a comparison with a threshold value, a distance d between the target object 300 and the primary device 100 can be determined based on the level of the primary current Iₚᵣᵢ or the input current Iᵢₙ. The measured value of the current intensity is usually higher, the closer the target object 300 is arranged to the primary device 100. For evaluation, the measured value is evaluated, optionally, by means of calibration values or by means of a calibration curve and the distance d is determined.

In the operation described above with a limited range, a target object 300 may be detected at a maximum distance dₘₐₓ of, for example, 7 mm. In the operation described above with an extended range, optionally with a higher standby power, the target object 300 may be detected at a maximum distance dₘₐₓ of, for example, 18 mm. In other examples, optionally with a different link voltage U_{ZK}, different ranges can be obtained.

A signal is then output in a step S7. Optionally, a signal is then output if a target object 300 has been detected; as an alternative or in addition, the signal can be output if no target object 300 has been detected.

Different output channels for the output signal are possible, depending on which interfaces are provided for the primary device 100 and how the output signal is to be further processed.

The output signal may be output via a network, for example via IO-Link, and transmitted to another device, such as an IO master.

The primary device 100 may also have a switching output that performs, for example, switch-on or switch-off when a target object 300 is detected, or when the distance d of the target object 300 exceeds or falls below a certain distance threshold value.

It is also conceivable to disconnect the link voltage U_{ZK} or the drive frequency of the primary resonant circuit when the target object 300 is detected. This makes it possible to prevent impermissible heating of the metallic object.

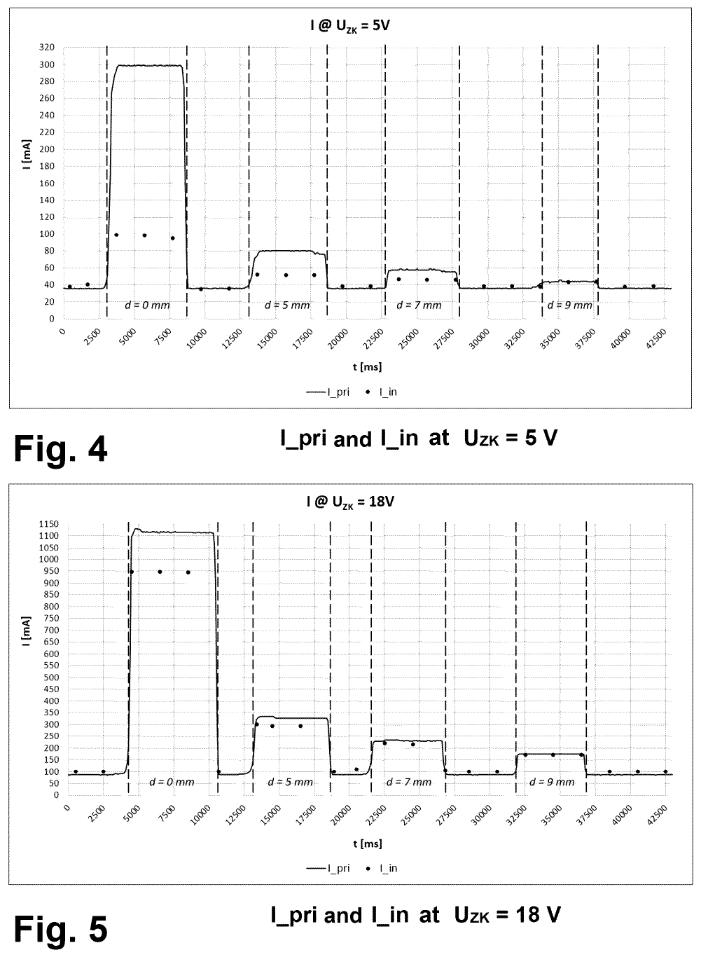

Example measurement results when operating the primary device are explained with reference to FIGS. 4 and 5. The exemplary embodiments of the primary device 100 and the method described above are taken as a starting point.

In the case shown in FIG. 4, the primary resonant circuit of the primary device 100 is operated with a link voltage U_{ZK} of 5 V.

In the case shown in FIG. 5, the primary resonant circuit of the primary device 100 is operated with a link voltage U_{ZK} of 18 V.

Example measurement results of the internal primary current I_pri and the input current I_in of the primary device 100 are shown at a link voltage U_{ZK} of 5 V (FIG. 4) or 18 V (FIG. 5) during metal detection at different distances d.

Optionally, the internal primary current Iₚᵣᵢ is a current intensity that is required during operation of the primary device 100 for the excitation of the primary resonant circuit in order to supply the primary resonant circuit with the required electrical power at a given fixed primary frequency. As an alternative or in addition to the internal primary current Iₚᵣᵢ, the input current Iᵢₙ of the primary device can be used, optionally a current intensity with which the primary device 100 is externally supplied with electrical power.

In the regions of the curves marked with certain values for the distance d, a metallic target object 300 was arranged at the distance d from the primary device 100. The distances d for the measurements were 0 mm, 5 mm, 7 mm and 9 mm.

It can be seen from the curves of FIGS. 4 and 5 that the measured current intensities are significantly above the baseline at the higher link voltage U_{ZK} of 18 V, even at greater distances d. This means that the target object 300 can still be reliably detected even at distances d of, for example, 7 mm or 9 mm.

FIGS. 4 and 5 also show that the measured current intensity depends on the distance d, and so the distance d can be gathered from the measured current intensity. Using data as shown in FIGS. 4 and 5 as calibration data, the primary device can be used in the second operating mode as a distance or proximity sensor that outputs a distance value or that outputs an output signal when a threshold value for the distance d is undershot. For calibration, a calibration curve can also be determined based on the measured data by fitting, for instance by fitting a polynomial, wherein the dependence of the measured current intensity on the distance d is specified.

The disclosure permits an extended functional scope of the primary side of the inductive coupler compared to known apparatus. Increased safety can be achieved, for example protection against a collision of the primary side with a metallic object by evaluating signals from the primary side in a superordinate controller.

It is also possible to identify metallic deposits at an early stage, for example on a front cap of a primary or secondary device. Maintenance and cleaning of the coupler system can thus be carried out in a targeted manner, and wear and energy consumption can be reduced.

It is possible to prevent foreign objects in the electromagnetic field of the primary side from heating up and presenting a hazard during the second operating mode, that is to say in standby mode.

The method and the primary device of this description permit various applications of the extended function of the primary device as a distance sensor or a proximity switch. For example, control optimization for positioning (metallic) tool holders can be performed, whereby an inductive coupling of the primary device to a secondary side is only carried out after the positioning. Various (metallic) devices can be included, of which only a subset has a secondary device that would be suitable for coupling and for inductive power transmission. Furthermore, the primary device can be used in the second operating mode as a limit switch for approaching a target object; when a sufficiently small distance from the target object is identified, for example, movement can be switched off and, if necessary, an inductive energy transmission can be started. Furthermore, foreign bodies can be identified on the primary side, for example by a contamination in the region of the primary device, for example a cap of the primary device, without the primary device having to be coupled to a secondary device for this. In addition, a primary-side installation situation in an enclosed metal environment can be checked even before a secondary side is installed and coupled.

### LIST OF REFERENCE SYMBOLS

10 System
100 Primary device; transmitter
101 Voltage converter
102 Voltage link; primary link
103 Amplifier
104 Single coil; primary resonant circuit with single coil and resonant capacitor
105 Voltage measuring unit
106 Current measuring unit
107 Evaluation and drive unit
108 Primary interface; interface (data transmission)
110 Input
120 Output
130 Data transmission
140 Power transmission
200 Secondary device; receiver
201 Voltage converter
202 Voltage link; secondary resonant circuit with single coil and resonant capacitor
203 Rectifier
204 Single coil; secondary resonant circuit
205 Voltage measuring unit
206 Current measuring unit
207 Evaluation and drive unit
208 Secondary interface; interface (data transmission)
300 Target object, foreign object (metallic)
D Distance
dₘₐₓ Maximum distance for detection
S1, S2, S3, S4, S5, S6, S7 Step

What is claimed is:

1. A method for operating a primary device for inductive power transmission, wherein the primary device includes a first operating mode and a second operating mode, wherein the primary device is designed such that the first and the second operating mode can be activated, the method comprising:
when the first operating mode is activated, exciting a primary resonant circuit of the primary device for transmitting a secondary power to a secondary resonant circuit of a secondary device coupled to the primary device;
when the second operating mode is activated, exciting the primary resonant circuit with a standby power and measuring a standby operating parameter;
detecting a target object in a detection area based on the measured standby operating parameter; and
generating an output signal.

2. The method according to claim 1, further comprising activating the first operating mode when the primary device is coupled to the secondary device.

3. The method according to claim 2, wherein the first operating mode is activated when also a data connection to the secondary device is established in order to initiate the inductive power transmission.

4. The method according to claim 1, comprising detecting a user input and activating the first operating mode or the second operating mode depending on the user input.

5. The method according to claim 4, comprising determining the standby power of the primary resonant circuit depending on the user input when the second operating mode is activated.

6. The method according to claim 1, comprising:
measuring a secondary power parameter of the secondary device when the first operating mode is activated; and
controlling a primary frequency at which the primary resonant circuit is excited in such a way that a predetermined value of the secondary power parameter is obtained.

7. The method according to claim 6, wherein the secondary power parameter is or includes a primary current or an input current of the primary device.

8. The method according to claim 1, comprising exciting the primary resonant circuit at a predetermined primary frequency when the second operating mode is activated.

9. The method according to claim 1, wherein the standby operating parameter comprises a primary current or an input current of the primary device.

10. The method according to claim 6, wherein detecting the target object in the detection area comprises comparing the power parameter with a predetermined threshold value.

11. The method according to claim 6, comprising determining the power parameter based on calibration data or a characteristic curve.

12. The method according to claim 1, comprising determining a distance between the target object and the primary device when the target object is detected in the detection area.

13. The method according to claim 1, wherein the output signal includes a switching signal and/or a warning signal.

14. A primary device for inductive power transmission, comprising
a primary resonant circuit; and
a control unit;
wherein the primary device is designed
to transmit a secondary power via a primary resonant circuit to a secondary resonant circuit of a secondary device coupled to the primary device when a first operating mode is activated; and
to excite the primary resonant circuit with a standby power when a second operating mode is activated; and
wherein the control unit is designed to measure a standby operating parameter of the primary device in the activated second operating mode, to detect a target object in a detection area based on the measured standby operating parameter, and to generate an output signal.

15. The primary device according to claim 14, wherein the control unit is designed, when the second operating mode is activated, to excite the primary resonant circuit at a predetermined primary frequency.

16. The primary device according to claim 14, wherein the standby operating parameter includes a primary current flowing from a link capacitor into an amplifier and the primary resonant circuit, or an input current of the primary device.

17. The primary device according to claim 14, wherein:
the primary device includes an interface for data transmission to an external unit; and
the control unit is designed to transmit the output signal via the interface to the external unit.

18. The primary device according to claim 17, wherein the interface is or includes a network interface.
